(19) United States
(12) Patent Application Publication
(10) Pub. No.: US 2010/0060806 A1
(43) Pub. Date: Mar. 11, 2010

(54) DISPLAY DEVICE AND ITS DRIVING METHOD

(76) Inventors: Keiichi Ina, Osaka (JP); Keisuke Yoshida, Osaka (JP)

Correspondence Address: HARNESS, DICKEY & PIERCE, P.L.C., P.O. BOX 8910, RESTON, VA, 20195, US

(21) Appl. No.: 12/450,724

(22) PCT Filed: Mar. 19, 2008
(86) PCT No.: PCT/JP2008/055071

§ 371 Date: Oct. 9, 2009

(30) Foreign Application Priority Data
Jul. 18, 2007 (JP) 2007-186498

(51) Int. Cl. H04N 9/30; G09G 5/10

(52) U.S. Cl. 348/791; 345/690

(57) ABSTRACT

In one embodiment of the present invention, a liquid crystal display device groups video signal lines SL1 to SLn every 12 video signal lines in order of arrangement and drives video signal lines in each group in a time division manner during a horizontal scanning period. The order of driving video signal lines in each group varies between an even frame and an odd frame, and for each line, in one of the frames, even-numbered video signal lines are driven earlier and in the other one of the frames, odd-numbered video signal lines are driven earlier. The first and last video signal lines to be driven correspond to blue. Accordingly, the numbers of times the video signal lines are influenced by push-up are limited to two for the even frame and zero for the odd frame and vice versa, whereby vertical streaks that occur at low temperatures are prevented, and insufficient charge is caused to occur only in video signal lines corresponding to blue, which makes it difficult for humans to recognize degradation in image quality aue to insufficient charge.

### TECHNICAL FIELD

The present invention relates to a display device that performs color display by driving video signal lines in a time division manner and a driving method therefor.

### BACKGROUND ART

In display devices in recent years, an increase in the definition of display images has proceeded. In active matrix-type display devices (e.g., active matrix-type liquid crystal display devices), such a number of signal lines (scanning signal lines and video signal lines) that is according to the resolution of display images is provided to a display panel. Hence, in the active matrix-type display devices, with an increase in the definition of display images, the number of signal lines that connect drive circuits to signal lines on the display panel increases and thus there is a need to arrange these signal lines in narrow pitches. Particularly, in display devices that perform color display, generally, the number of video signal lines is larger than the number of scanning signal lines and thus there is a need to arrange signal lines that connect a video signal line drive circuit to video signal lines in narrower pitches.

To solve the above problem, a method (hereinafter, referred to as video signal line time division drive) is conventionally known in which video signal lines are grouped every a video signal lines (a is an integer greater than or equal to two) in order of arrangement, each group is allotted one output terminal of a video signal line drive circuit, and video signal lines in each group are driven in a time division manner during a horizontal scanning period (e.g., Patent Document 1). In display devices that perform video signal line time division drive, a video signal line selection circuit that switches which video signal line a voltage outputted from a video signal line drive circuit is to be applied to is provided between the video signal line drive circuit and video signal lines. Accordingly, the number of signal lines that connect the video signal line drive circuit to the video signal lines can be reduced by 1/a.

However, in display devices that perform video signal line time division drive, streaks in a video signal line direction (hereinafter, referred to as vertical streaks) may occur on a display screen in a cycle of a video signal lines.

FIG. 7 is a diagram showing parasitic capacitances that occur between video signal lines of a liquid crystal display device. As shown in FIG. 7, two video signal lines SLj and SLj+1 are capacitance-coupled to each other through two parasitic capacitances Csd1 and Csd2. Thus, when, after applying a certain voltage to the video signal line SLj, a voltage is applied to the video signal line SLj+1 adjacent thereto, the voltage on the video signal line SLj is influenced thereby and thus fluctuates (hereinafter, this phenomenon is referred to as “push-up”).

The time when a video signal line is influenced by push-up is when the voltage on a video signal line adjacent thereto is changed. When video signal lines in a group are always sequentially driven from the left, a video signal line arranged in the leftmost position in the group is influenced by push-up twice during a horizontal scanning period and pixel circuits connected to the video signal line are also influenced by push-up twice. On the other hand, a video signal line arranged in the rightmost position in the group is not influenced by push-up and pixel circuits connected to the video signal line are not influenced by push-up, either. As such, pixel circuits that are likely to be influenced by push-up are aligned in the video signal line direction and pixel circuits that are not influenced by push-up are also aligned in the video signal line direction and thus vertical streaks occur on a display screen.

The vertical streaks prominently appear when a halftone solid screen (screen with uniform luminance) is displayed.

In view of the above, to prevent vertical streaks in display devices that perform video signal line time division drive, a method of devising the order of driving video signal lines in a group is considered. For example, there is a method in which the order of driving video signal lines in a group is reversed between an even frame and an odd frame (see FIG. 5 which will be described later). According to the method, all video signal lines in a group are influenced by push-up twice during a horizontal scanning period in an even frame and an odd frame in all. By thus equalizing the numbers of times video signal lines are influenced by push-up, between the video signal lines, vertical streaks can be prevented to a certain extent.

Also, Patent Document 2 discloses that the order of driving video signal lines in a group is made variable to prevent vertical streaks in a display device that performs video signal line time division drive. This document discloses that the order of driving four video signal lines Si to Si+3 is switched in the manner shown in FIGS. 8A and 8B.

[Patent Document 1] Japanese Patent Application Laid-Open No. 6-138851

[Patent Document 2] Japanese Patent Application Laid-Open No. 2003-58133

### DISCLOSURE OF THE INVENTION

### Problems to be Solved by the Invention

However, in the method in which the order of driving video signal lines in a group is reversed between an even frame and an odd frame, vertical streaks may occur on a display screen when the operating conditions are severe. For example, in a liquid crystal display device, the response speed of liquid crystal decreases at low temperatures and thus vertical streaks are likely to occur. Hence, in a liquid crystal display device in which the order of driving video signal lines in a group is reversed between an even frame and an odd frame, vertical streaks that do not occur at normal temperature may occur at low temperatures.

Also, in display devices that perform video signal line time division drive, insufficient charge is likely to occur in the first and last video signal lines to be driven in a group. Hence, in the case of color display devices, unless the order of driving video signal lines in a group is determined taking into account that color display is performed, insufficient charge occurs in video signal lines corresponding to a plurality of colors, degrading the image quality of a display screen. In Patent Document 2, when the order of driving video signal lines in a group is determined, the fact that color display is performed is not taken into account.

An object of the present invention is therefore to prevent vertical streaks and degradation in image quality due to insufficient charge in a display device that performs color display by driving video signal lines in a time division manner.

### Means for Solving the Problems

A first aspect of the present invention provides a display device that performs color display by driving video signal lines in a time division manner, the display device including: a plurality of pixel circuits arranged side by side in a first and a second direction, each alignment of pixel circuits in the second direction corresponding to any one of colors used for color display; a plurality of scanning signal lines, each of which is connected in a shared manner to pixel circuits aligned in the first direction; a plurality of video signal lines, each of which is connected in a shared manner to pixel circuits aligned in the second direction, the video signal lines being grouped every predetermined number of video signal lines according to order of arrangement; a scanning signal line drive circuit for selecting the scanning signal lines; a video signal line drive circuit for outputting to each group of the video signal lines voltages to be applied to video signal lines in the group, in a time division manner during a horizontal scanning period; and a video signal line selection circuit for selecting one video signal line from each group and providing voltages outputted from the video signal line drive circuit, to the selected video signal lines, respectively, wherein order of driving video signal lines in each group varies between an even frame and an odd frame, and for each line, in one of the frames, even-numbered video signal lines in the group are driven earlier than odd-numbered video signal lines and in other one of the frames, the odd-numbered video signal lines in the group are driven earlier than the even-numbered video signal lines and a last video signal line to be driven in the group is a video signal line corresponding to a specific color.

In accordance with a second aspect of the present invention, in the first aspect of the present invention, in addition to the last video signal line to be driven in the group, a first video signal line to be driven in the group is a video signal line corresponding to the specific color.

In accordance with a third aspect of the present invention, in the first aspect of the present invention, the order of driving video signal lines in the group is reversed between the even frame and the odd frame.

In accordance with a fourth aspect of the present invention, in the first aspect of the present invention, the order of driving video signal lines in the group varies between even lines and odd lines.

In accordance with a fifth aspect of the present invention, in the fourth aspect of the present invention, the order of driving video signal lines in the group is reversed between the even frame and the odd frame.

In accordance with a sixth aspect of the present invention, in the fourth aspect of the present invention, a result of adding up a drive order number for the even lines in the even frame, a drive order number for the odd lines in the even frame, a drive order number for the even lines in the odd frame, and a drive order number for the odd lines in the odd frame is same for all video signal lines in the group.

In accordance with a seventh aspect of the present invention, in the fourth aspect of the present invention, the last video signal line to be driven in the group varies between a case of the even lines in the even frame, a case of the odd lines in the even frame, a case of the even lines in the odd frame, and a case of the odd lines in the odd frame.

In accordance with an eighth aspect of the present invention, in the seventh aspect of the present invention, in addition to the last video signal line to be driven in the group, a first video signal line to be driven in the group varies between the case of the even lines in the even frame, the case of the odd lines in the even frame, the case of the even lines in the odd frame, and the case of the odd lines in the odd frame.

In accordance with a ninth aspect of the present invention, in the first aspect of the present invention, the specific color is a color where it is most difficult for humans to recognize a change in luminance among the colors used for color display.

In accordance with a tenth aspect of the present invention, in the ninth aspect of the present invention, as the pixel circuits, pixel circuits corresponding to red, green, and blue are provided, and the specific color is blue.

In accordance with an eleventh aspect of the present invention, in the first aspect of the present invention, as the pixel circuits, pixel circuits corresponding to red, green, and blue are provided, the video signal lines are grouped every 12 video signal lines, each group including video signal lines R1 to R4 corresponding to red, video signal lines G1 to G4 corresponding to green, and video signal lines B1 to B4 corresponding to blue and the video signal lines being arranged in order of R1, G1, B1, R2, G2, B2, R3, G3, B3, R4, G4, and B4, and 12 video signal lines in each group are driven in order of

B1, R1, G2, R3, B3, G4, G1, R2, B2, G3, R4, and B4 for even lines in the even frame and in order of B2, R2, G1, B4, R4, G3, G2, B1, R1, G4, R3, and B3 for odd lines in the even frame and in order reverse to that for the even frame, for the odd frame.

In accordance with a twelfth aspect of the present invention, in the first aspect of the present invention, the pixel circuits each include a liquid crystal capacitance.

A thirteenth aspect of the present invention provides a driving method for a display device that includes a plurality of pixel circuits arranged side by side in a first and a second direction of the present invention, each alignment of pixel circuits in the second direction corresponding to any one of colors used for color display; a plurality of scanning signal lines, each of which is connected in a shared manner to pixel circuits aligned in the first direction; and a plurality of video signal lines, each of which is connected in a shared manner to pixel circuits aligned in the second direction, the video signal lines being grouped every predetermined number of video signal lines according to order of arrangement, the driving method including the steps of: selecting the scanning signal lines; outputting to each group of the video signal lines voltages to be applied to video signal lines in the group, in a time division manner during a horizontal scanning period; and selecting one video signal line from each group and providing voltages each outputted in a time division manner, to the selected video signal lines, respectively, wherein order of driving video signal lines in each group varies between an even frame and an odd frame, and for each line, in one of the frames, even-numbered video signal lines in the group are driven earlier than odd-numbered video signal lines and in other one of the frames, the odd-numbered video signal lines in the group are driven earlier than the even-numbered video signal lines and a last video signal line to be driven in the group is a video signal line corresponding to a specific color.

### EFFECT OF THE INVENTION

According to the first or thirteenth aspect of the present invention, in a frame in which even-numbered video signal lines are driven earlier, the even-numbered video signal lines are influenced by push-up twice during a horizontal scanning period, and in a frame in which odd-numbered video signal lines are driven earlier, the odd-numbered video signal lines are influenced by push-up twice during a horizontal scanning period. By thus limiting the numbers of times video signal lines are influenced by push-up to two for an even frame and zero for an odd frame and zero for the even frame and two for the odd frame, occurrence of vertical streaks can be prevented even when the operating conditions are severe, e.g., at low temperatures. In addition, by making the last video signal line to be driven in each group to be a video signal line corresponding to a specific color, video signal lines particularly where insufficient charge is likely to occur are limited to video signal lines corresponding to one color, enabling to prevent degradation in image quality due to insufficient charge.

According to the second aspect of the present invention, by making the first and last video signal lines to be driven in each group to be video signal lines corresponding to the specific color, video signal lines where insufficient charge occurs are limited to video signal lines corresponding to one color, enabling to prevent degradation in image quality due to insufficient charge.

According to the third aspect of the present invention, by making the order of driving video signal lines in each group to be reversed between an even frame and an odd frame, the influences of push-up received by the video signal lines become symmetric in the group with respect to a first direction. Accordingly, occurrence of vertical streaks can be more effectively prevented.

According to the fourth aspect of the present invention, by switching the order of driving video signal lines in each group between even lines and odd lines, the influences of push-up received by the video signal lines are averaged between the lines, enabling to more effectively prevent occurrence of vertical streaks.

According to the fifth aspect of the present invention, by making the order of driving video signal lines in each group to be reversed between an even frame and an odd frame and by switching the order of driving between even lines and odd lines, the influences of push-up received by the video signal lines become symmetric in the group with respect to the first direction and thus are averaged between the lines. Accordingly, occurrence of vertical streaks can be more effectively prevented.

According to the sixth aspect of the present invention, by making results of adding up drive order numbers of respective video signal lines in each group identical, the influences of push-up received by the video signal lines in the group are averaged, enabling to more effectively prevent occurrence of vertical streaks.

According to the seventh aspect of the present invention, by switching the last video signal line to be driven in each group to another on a frame-by-frame basis and a line-by-line basis, video signal lines where insufficient charge occurs are switched to another, enabling to more effectively prevent degradation in image quality due to insufficient charge.

According to the eighth aspect of the present invention, by switching the first and last video signal line to be driven in each group to another on a frame-by-frame basis and a line-by-line basis, video signal lines where insufficient charge occurs are switched to another, enabling to more effectively prevent degradation in image quality due to insufficient charge.

According to the ninth aspect of the present invention, since the last video signal line to be driven in each group corresponds to a color where it is difficult for humans to recognize a change in luminance, video signal lines particularly where insufficient charge is likely to occur are limited to video signal lines corresponding to the color where it is difficult for humans to recognize a change in luminance. This can make it difficult for humans to recognize degradation in image quality due to insufficient charge.

According to the tenth aspect of the present invention, the color where it is most difficult for humans to recognize a change in luminance among red, green, and blue is blue and the last video signal line to be driven in each group corresponds to blue. Thus, video signal lines particularly where insufficient charge is likely to occur are limited to video signal lines corresponding to blue where it is difficult for humans to recognize a change in luminance. This can make it difficult for humans to recognize degradation in image quality due to insufficient charge in a display device that performs color display using an RGB scheme by driving video signal lines in a time division manner.

According to the eleventh aspect of the present invention, in a display device that performs color display using an RGB scheme by driving, in a time division manner, video signal lines which are grouped every 12 video signal lines, vertical streaks and degradation in image quality due to insufficient charge can be prevented.

According to the twelfth aspect of the present invention, in a liquid crystal display device that performs color display by driving video signal lines in a time division manner, vertical streaks and degradation in image quality due to insufficient charge can be prevented.

### BRIEF DESCRIPTION OF THE DRAWINGS

FIG. 1 is a block diagram showing a configuration of a liquid crystal display device according to an embodiment of the present invention.

FIG. 2 is an equivalent circuit diagram of a pixel circuit of the liquid crystal display device shown in FIG. 1.

FIG. 3 is a diagram showing the order of driving video signal lines in a group in the liquid crystal display device shown in FIG. 1.

FIG. 4 is a timing chart of the liquid crystal display device shown in FIG. 1.

FIG. 5 is a diagram showing the order of driving video signal lines in a group in a liquid crystal display device according to a first comparative example.

FIG. 6 is a diagram showing the order of driving video signal lines in a group in a liquid crystal display device according to a second comparative example.

FIG. 7 is a diagram showing parasitic capacitances that occur between video signal lines of a liquid crystal display device.

FIG. 8A is a diagram showing an example of switching of the order of driving video signal lines in a group in a conventional liquid crystal display device.

FIG. 8B is a diagram showing another example of switching of the order of driving video signal lines in a group in the conventional liquid crystal display device.

### DESCRIPTION OF REFERENCE NUMERALS

1 liquid crystal display device

2 pixel array

3 scanning signal line drive circuit

4 video signal line drive circuit

5 and XR1 to XR4, XG1 to XG4, and XB1 to XB4 analog switch

6 switch control circuit

11 TFT

12 liquid crystal capacitance

13 auxiliary capacitance

Pij pixel circuit

GL1 to GLm scanning signal line

SL1 to SLn, R1 to R4, G1 to G4, and B1 to B4 video signal line

CR1 to CR4, CG1 to CG4, and CB1 to CB4 switch control signal

V1 to Vt analog voltage

### BEST MODE FOR CARRYING OUT THE INVENTION

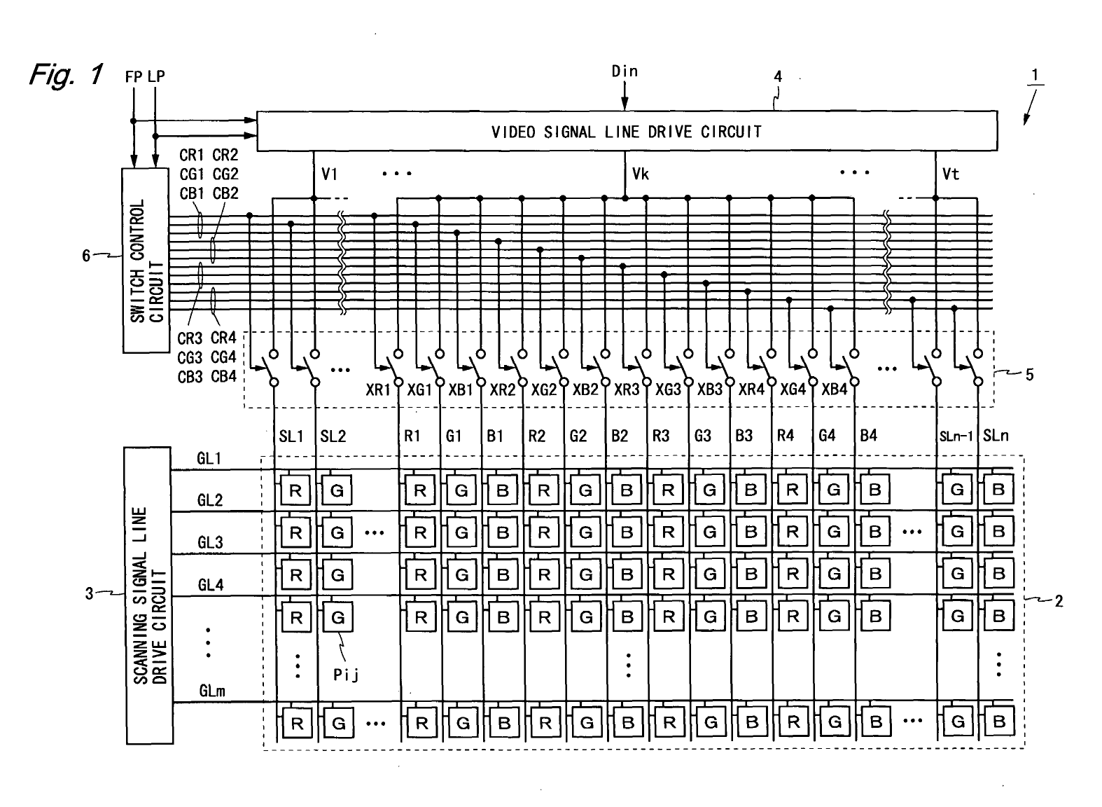

FIG. 1 is a block diagram showing a configuration of a liquid crystal display device according to an embodiment of the present invention. A liquid crystal display device 1 shown in

FIG. 1 includes a pixel array 2, a scanning signal line drive circuit 3, a video signal line drive circuit 4, n analog switches 5, and a switch control circuit 6, and performs color display using an RGB scheme by video signal line time division drive. In the following, it is assumed that m is an integer greater than or equal to 2, n is a multiple of 12, t is n/12, i is an integer between 1 and m, j is an integer between 1 and n, and k is an integer between 1 and t.

The pixel array 2 includes m scanning signal lines GL1 to GLm, n video signal lines SL1 to SLn, and (m×n) pixel circuits Pij arranged two-dimensionally. The scanning signal lines GL1 to GLm are arranged in parallel to each other and the video signal lines SL1 to SLn are arranged in parallel to each other so as to be orthogonal to the scanning signal lines GL1 to GLm. A pixel circuit Pij is arranged near an intersection of a scanning signal line GLi and a video signal line SLj. Each pixel circuit Pij corresponds to one pixel or display element. Each of the scanning signal lines GL1 to GLm is connected in a shared manner to pixel circuits Pij arranged in one same row and each of the video signal lines SL1 to SLn is connected in a shared manner to pixel circuits Pij arranged in one same column.

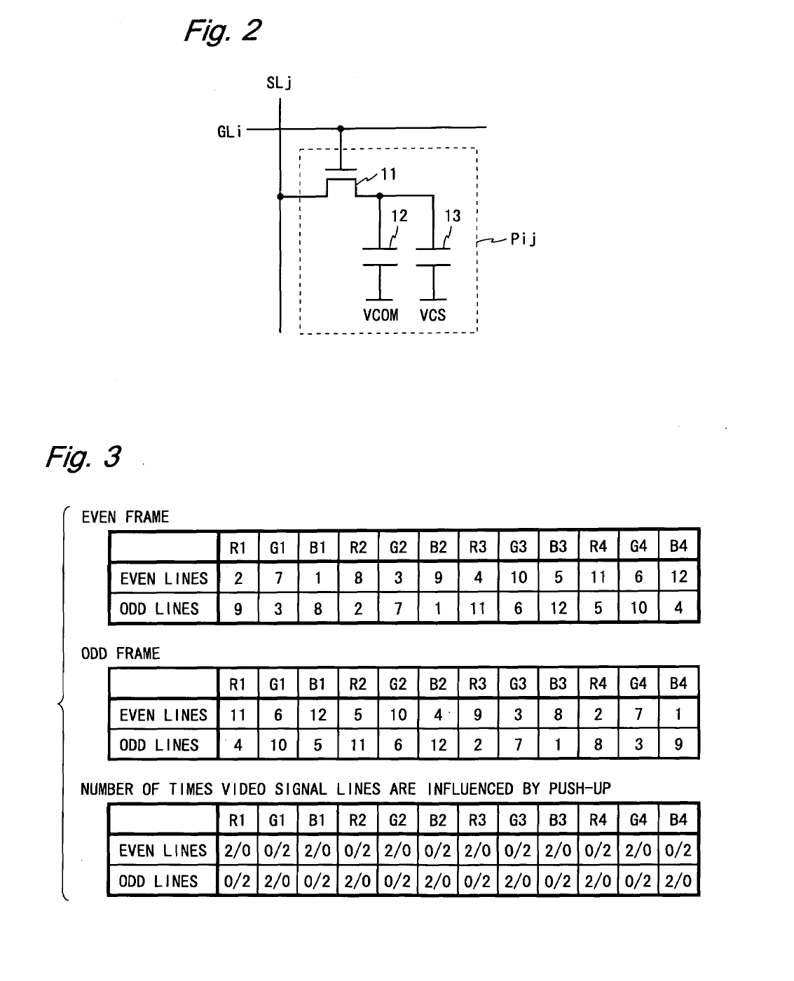

FIG. 2 is an equivalent circuit diagram of a pixel circuit Pij. The pixel circuit Pij includes, as shown in FIG. 2, a TFT (Thin Film Transistor) 11, a liquid crystal capacitance 12, and an auxiliary capacitance 13. A gate terminal of the TFT 11 is connected to a scanning signal line GLi, a source terminal is connected to a video signal line SLj, and a drain terminal is connected to one electrode of each of the liquid crystal capacitance 12 and the auxiliary capacitance 13. To the other electrodes of the liquid crystal capacitance 12 and the auxiliary capacitance 13 are respectively applied a common electrode voltage VCOM and an auxiliary capacitance voltage VCS.

Pixel circuits Pij in each column correspond to any one of red, green, and blue which are used for color display. Pixel circuits (represented as R) in the first, fourth, seventh, . . . columns correspond to red, pixel circuits (represented as G) in the second, fifth, eighth, . . . columns correspond to green, and pixel circuits (represented as B) in the third, sixth, ninth, . . . columns correspond to blue. As such, the pixel circuits Pij are arranged side by side in a first direction (row direction) and a second direction (column direction), and each alignment of pixel circuits Pij in the second direction (a column of pixel circuits) corresponds to anyone of colors used for color display.

The scanning signal line drive circuit 3 selects the scanning signal lines GL1 to GLm. More specifically, the scanning signal line drive circuit 3 sequentially selects one scanning signal line from among the scanning signal lines GL1 to GLm every horizontal scanning period and provides a select voltage (e.g., a high level) to the selected scanning signal line and provides a non-select voltage (e.g., a low level) to the other scanning signal lines. Accordingly, pixel circuits Pij arranged in one same row are selected at one time.

The video signal lines SL1 to SLn are grouped every 12 video signal lines according to the order of arrangement, whereby t (=n/12) groups are formed. Hereinafter, 12 video signal lines belonging to each group are referred to as R1, G1, B1, R2, G2, B2, R3, G3, B3, R4, G4, and B4 in order of arrangement. The video signal lines R1 to R4 are video signal lines corresponding to red, the video signal lines G1 to G4 are video signal lines corresponding to green, and the video signal lines B1 to B4 are video signal lines corresponding to blue.

The video signal line drive circuit 4 outputs to each group of the video signal lines SL1 to SLn voltages to be applied to video signal lines in the group, in a time division manner during a horizontal scanning period. More specifically, the video signal line drive circuit 4 has t (equal to the number of groups of video signal lines) output terminals, and includes a register that stores at least n video data units, a data selection circuit, and t D/A converters (none of them is shown). To the video signal line drive circuit 4 are supplied n video data units Din per horizontal scanning period from an external source. The n video data units are stored in the register. The data selection circuit performs a process of selecting t video data units in predetermined order from among the n video data units stored in the register, 12 times during a horizontal scanning period. The t D/A converters each convert one video data unit outputted from the data selection circuit into an analog voltage. An analog voltage obtained by a k-th D/A converter is outputted from a k-th output terminal of the video signal line drive circuit 4 as an analog voltage Vk.

The analog switches 5 and the switch control circuit 6 function as a video signal line selection circuit, as shown below, that selects one video signal line from each group and provides voltages outputted from the video signal line drive circuit 4, to the selected video signal lines, respectively.

Twelve video signal lines R1 to R4, G1 to G4, and B1 to B4 belonging to a k-th group are associated with the k-th output terminal of the video signal line drive circuit 4, and 12 analog switches 5 are provided therebetween. More specifically, one ends of the video signal lines R1 to R4, G1 to G4, and B1 to B4 are respectively connected to analog switches XR1 to XR4, XG1 to XG4, and XB1 to XB4 and the other ends of the 12 analog switches are all connected to the k-th output terminal of the video signal line drive circuit 4. One of the 12 analog switches goes into a conduction state and an analog voltage Vk is provided to one of the 12 video signal lines belonging to the k-th group. Note that the analog switches 5 are formed by, for example, using TFTs on a liquid crystal panel where the pixel array 2 is formed.

The switch control circuit 6 outputs 12 switch control signals CR1 to CR4, CG1 to CG4, and CB1 to CB4 based on two control signals FP and LP. The control signal FP is a signal indicating whether it is an even frame or odd frame and changes between a high level and a low level every frame period. The control signal LP is a signal indicating whether it is an even line or odd line and changes between a high level and a low level every horizontal scanning period. The switch control signals CR1 to CR4, CG1 to CG4, and CB1 to CB4 are supplied to control terminals of 12 analog switches XR1 to XR4, XG1 to XG4, and XB1 to XB4 provided to each group. In the following, it is assumed that each analog switch 5 goes into a conduction state when a corresponding switch control signal is at a high level and goes into a non-conduction state when the corresponding switch control signal is at a low level.

In the liquid crystal display device 1, one horizontal scanning period is divided into 12 (equal to the number of video signal lines in a group) small periods. The switch control circuit 6 controls each of 12 switch control signals CR1 to CR4, CG1 to CG4, and CB1 to CB4 to go to a high level during only one small period in a horizontal scanning period. For example, when the switch control signal CR1 is at a high level, analog switches XR1 provided to the respective groups go into a conduction state and thus the t output terminals of the video signal line drive circuit 4 are electrically connected to video signal lines R1 belonging to the respective groups. At this time, an analog voltage Vk is provided to a video signal line R1 belonging to the k-th group. As such, when the switch control signal CR1 is at a high level, video signal lines R1 (t video signal lines in total) belonging to the respective groups are connected to the t output terminals of the video signal line drive circuit 4 and driven at one time by the video signal line drive circuit 4. Likewise, when the switch control signals CR2 to CR4, CG1 to CG4, and CB1 to CB4 are at a high level, video signal lines R2 to R4, G1 to G4, and R1 to R4 belonging to the respective groups are respectively driven at one time by the video signal line drive circuit 4.

The switch control circuit 6 switches the order of bringing the switch control signals CR1 to CR4, CG1 to CG4, and CB1 to CB4 to a high level, based on the control signals FP and LP. Thus, the order of driving 12 video signal lines in each group varies between the case of even lines in an even frame, the case of odd lines in the even frame, the case of the even lines in an odd frame, and the case of the odd lines in the odd frame (see FIG. 3 which will be described later).

The control signals FP and LP are supplied not only to the switch control circuit 6 but also to the video signal line drive circuit 4. The data selection circuit included in the video signal line drive circuit 4 selects, based on the control signals FP and LP, t video data units from among n video data units according to the order of driving 12 video signal lines in a group.

As such, the liquid crystal display device 1 groups the video signal lines SL1 to SLn every 12 video signal lines according to the order of arrangement, allots one output terminal of the video signal line drive circuit 4 to each group, and drives video signal lines in each group in a time division manner during a horizontal scanning period and switches the order of driving video signal lines in each group in four ways based on control signals FP and LP.

FIG. 3 is a diagram showing the order of driving video signal lines in a group in the liquid crystal display device 1. As shown in FIG. 3, 12 video signal lines in a group are driven in order of B1, R1, G2, R3, B3, G4, G1, R2, B2, G3, R4, and B4 for even lines in an even frame and driven in order of B2, R2, G1, B4, R4, G3, G2, B1, R1, G4, R3, and B3 for odd lines in the even frame and driven in the order reverse to that for the even lines in the even frame, for the even lines in an odd frame and driven in the order reverse to that for the odd lines in the even frame, for the odd lines in the odd frame. Note that since the order of driving video signal lines and the order of writing voltages into pixel circuits are the same, it can be said that FIG. 3 also represents the order of writing voltages into pixel circuits.

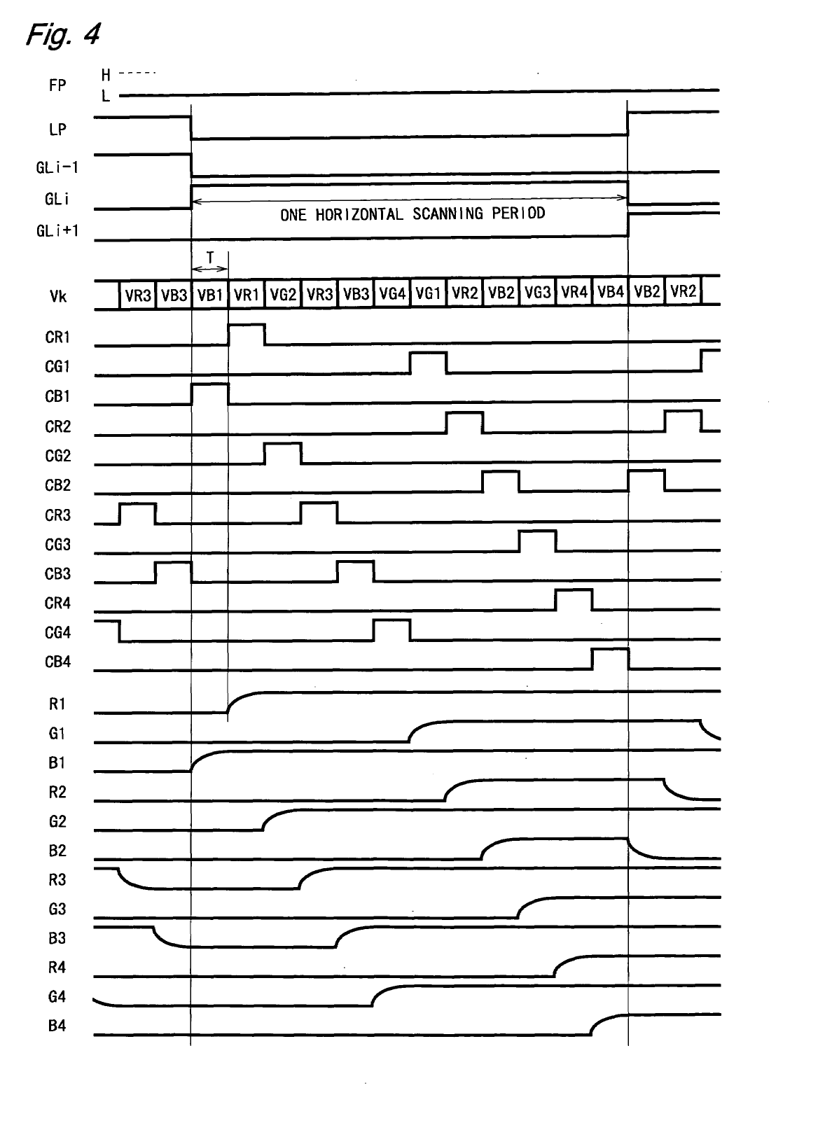

FIG. 4 is a timing chart of the liquid crystal display device 1 for even lines in an even frame. As shown in FIG. 4, the voltage on a scanning signal line GLi is a select voltage (high level) over one horizontal scanning period and the selection period of the scanning signal line GLi is divided into 12 small periods, each having length T.

During the first small period, a switch control signal CB1 goes to a high level and thus an analog switch XB1 among 12 analog switches provided to each group goes into a conduction state. At this time, an analog voltage Vk to be written into a pixel circuit Pij connected to a video signal line B1 belonging to the k-th group and the scanning signal line GLi is outputted from the k-th output terminal of the video signal line drive circuit 4. The analog voltage Vk is applied to the video signal line B1 belonging to the k-th group through the analog switch XB1 provided to the k-th group. Likewise, during the 2nd to 12th small periods, the analog voltage Vk is applied to video signal lines R1, G2, R3, B3, G4, G1, R2, B2, G3, R4, and B4 belonging to the k-th group, in this order.

The analog voltages applied to the video signal lines R1 to R4, G1 to G4, and B1 to B4 are respectively written into pixel circuits Pij connected to the respective video signal lines and the scanning signal line GLi, during a period in which the voltage on the scanning signal line GLi is at a high level. As such, for even lines in an even frame, 12 video signal lines in each group are driven in the order shown in FIG. 3 and analog voltages applied to the 12 video signal lines are respectively written into 12 pixel circuits Pij.

The liquid crystal display device 1 operates in the same manner as that described above, for odd lines in the even frame, the even lines in an odd frame, and the odd lines in the odd frame, too. Note, however, that 12 video signal lines in a group are driven in the order shown in FIG. 3.

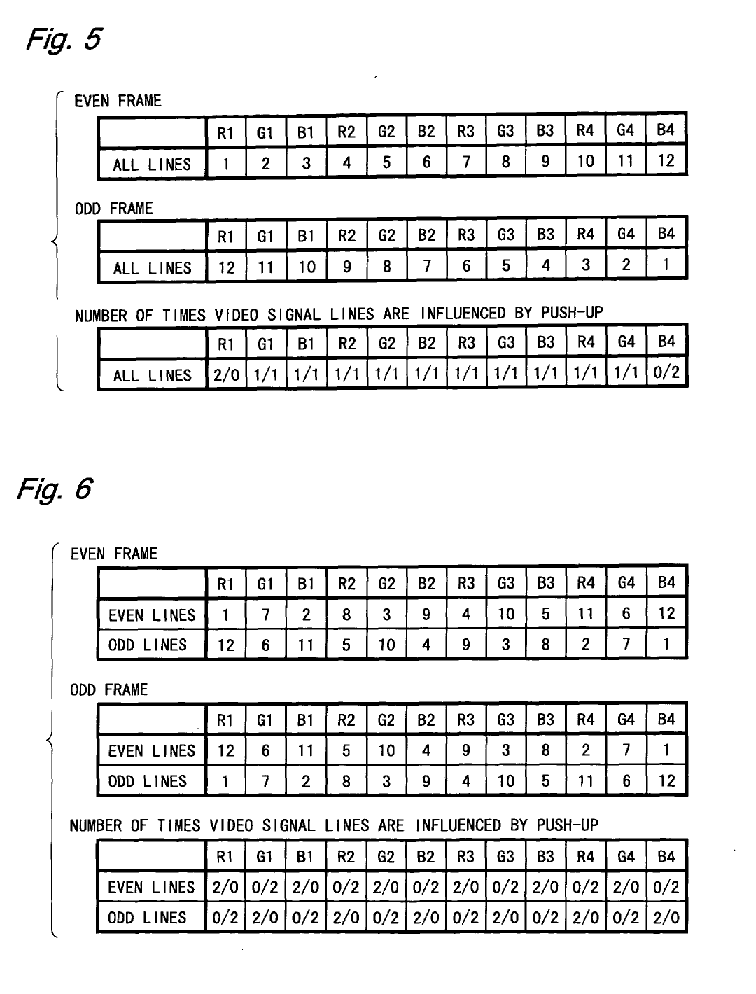

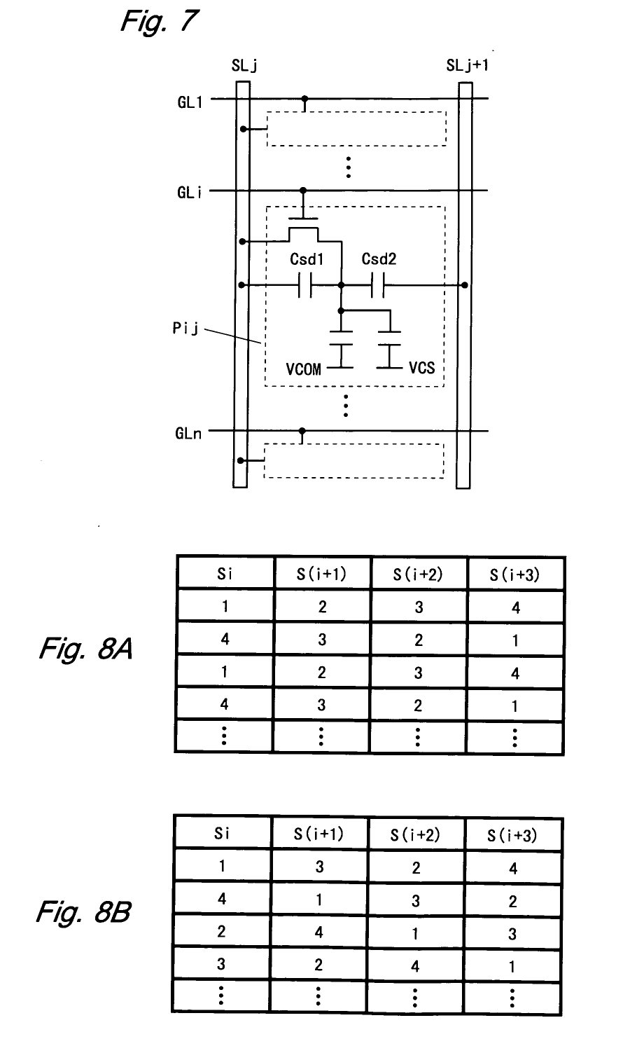

Effects of the liquid crystal display device 1 according to the present embodiment will be described below with reference to FIGS. 3, 5, and 6. Here, the numbers of times video signal lines are influenced by push-up are compared between the case of driving 12 video signal lines in a group in the order shown in FIG. 3 (liquid crystal display device 1), the case of driving in the order shown in FIG. 5 (first comparative example), and the case of driving in the order shown in FIG. 6 (second comparative example). In these drawings and the following description, the fact that a video signal line is influenced by push-up A times in an even frame and B times in an odd frame is represented as “A/B”.

As described above, the time when a video signal line is influenced by push-up is when the voltage on a video signal line adjacent thereto (a left or right adjacent video signal line) is changed. Note that a video signal line arranged in the leftmost position in a group is influenced by push-up when the voltage on a video signal line arranged in the rightmost position in a left adjacent group is changed and a video signal line arranged in the rightmost position in the group is influenced by push-up when the voltage on a video signal line arranged in the leftmost position in a right adjacent group is changed.

In the first comparative example shown in FIG. 5, 12 video signal lines in a group are driven sequentially from the left for an even frame and driven sequentially from the right for an odd frame. In this case, the numbers of times the video signal lines are influenced by push-up are as shown in the bottom section of FIG. 5. Specifically, the number of times a video signal line R1 is influenced by push-up is 2/0 (two times in the even frame and zero times in the odd frame), the number of times a video signal line B4 is influenced by push-up is 0/2 (zero times in the even frame and two times in the odd frame), and the numbers of times the other ten video signal lines are influenced by push-up are 1/1 (one time in the even frame and one time in the odd frame).

In the first comparative example, the numbers of times the video signal lines are influenced by push-up are any one of 2/0, 1/1, and 0/2. By thus equalizing the numbers of times the video signal lines are influenced by push-up, between the video signal lines, vertical streaks can be prevented to a certain extent. However, in the liquid crystal display device, charges in pixel circuits become insufficient and the viscosity of liquid crystal increases at low temperatures. Accordingly, a difference in terms of appearance occurs in liquid crystal application voltage between pixel circuits connected to a video signal line influenced by push-up 2/0 times and pixel circuits connected to a video signal line influenced by push-up 1/1 times. The difference appears on a display screen as a difference in luminance between pixels and thus a vertical streak occurs on the display screen. As such, in the first comparative example, although vertical streaks at room temperature can be prevented, vertical streaks at low temperatures cannot be prevented.

In the liquid crystal display device 1, 12 video signal lines in a group are driven in the order shown in FIG. 3. In this case, the numbers of times the 12 video signal lines are influenced by push-up are as shown in the bottom section of FIG. 3. Specifically, for even lines, the numbers of times odd-numbered video signal lines (video signal lines R1, B1, G2, R3, B3, and G4) in the group are influenced by push-up are 2/0 and the numbers of times even-numbered video signal lines (video signal lines G1, R2, B2, G3, R4, and G4) in the group are influenced by push-up are 0/2. For odd lines, the numbers of times the odd-numbered video signal lines in the group are influenced by push-up are 0/2 and the numbers of times the even-numbered video signal lines in the group are influenced by push-up are 2/0.

As such, in the liquid crystal display device 1, the order of driving video signal lines in each group varies between an even frame and an odd frame. For even lines, in the odd frame, even-numbered video signal lines in the group are driven earlier than odd-numbered video signal lines and in the even frame, the odd-numbered video signal lines in the group are driven earlier than the even-numbered video signal lines. For odd lines, in the even frame, the even-numbered video signal lines in the group are driven earlier than the odd-numbered video signal lines and in the odd frame, the odd-numbered video signal lines in the group are driven earlier than the even-numbered video signal lines.

Thus, in a frame in which the even-numbered video signal lines are driven earlier, the even-numbered video signal lines are influenced by push-up twice during a horizontal scanning period, and in a frame in which the odd-numbered video signal lines are driven earlier, the odd-numbered video signal lines are influenced by push-up twice during a horizontal scanning period. Accordingly, the numbers of times the video signal lines are influenced by push-up are limited to 2/0 and 0/2. Therefore, unlike the first comparative example, even when the operating conditions are severe, e.g., at low temperatures, a difference in terms of appearance does not occur in liquid crystal application voltage and thus occurrence of vertical streaks can be prevented.

Also, as shown in FIG. 3, since the order of driving video signal lines in a group is reversed between an even frame and an odd frame and varies between even lines and odd lines, the influences of push-up received by the video signal lines are symmetric with respect to the row direction in the group and thus are averaged between the lines. Accordingly, occurrence of vertical streaks can be more effectively prevented.

In addition, in FIG. 3, a result of adding up a drive order number for even lines in an even frame, a drive order number for odd lines in the even frame, a drive order number for the even lines in an odd frame, and a drive order number for the odd lines in the odd frame is the same. For example, when drive order numbers for the video signal R1 are added up, 2+9+11+4=26 and this result matches each of results of adding up drive order numbers for the respective video signal lines R2 to R4, G1 to G4, and B1 to B4. By thus making the results of adding up drive order numbers of video signal lines in a group identical, the influences of push-up received by the video signal lines in the group are averaged and thus occurrence of vertical streaks can be more effectively prevented.

In FIG. 3, the first and last video signal lines to be driven are respectively B1 and B4 for even lines in an even frame, B2 and B3 for odd lines in the even frame, B4 and B1 for the even lines in an odd frame, and B3 and B2 for the odd lines in the odd frame. As such, the first and last video signal lines to be driven in the group are any of the video signal lines B1 to B4 corresponding to blue.

Generally, in display devices that perform video signal line time division drive, insufficient charge is likely to occur in the first and last video signal lines to be driven in each group and insufficient charge is likely to occur particularly in the last video signal line to be driven in the group. The color where it is most difficult for humans to recognize a change in luminance among red, green, and blue is blue. Taking into account these points, in the liquid crystal display device 1, the first and last video signal lines to be driven in each group are determined to be any of the video signal lines B1 to B4 corresponding to blue. This can make it difficult for humans to recognize degradation in image quality due to insufficient charge in a liquid crystal display device that performs color display using an RGB scheme by driving video signal lines in a time division manner.

In addition, in FIG. 3, the first video signal line to be driven in the group varies between the case of even lines in an even frame, the case of odd lines in the even frame, the case of the even lines in an odd frame, and the case of the odd lines in the odd frame, and so does the last video signal line to be driven in the group. By thus switching the first and last video signal lines to be driven in the group to another on a frame-by-frame basis and a line-by-line basis, video signal lines where insufficient charge occurs are switched to another and thus degradation in image quality due to insufficient charge can be more effectively prevented.

Note that, in the second comparative example shown in FIG. 6, the numbers of times video signal lines are influenced by push-up are the same as those for the case of the liquid crystal display device 1 (FIG. 3). However, since a video signal line R1 is driven last in a group in some cases, insufficient charge is likely to occur particularly in the video signal line R1. Since insufficient charge is likely to occur particularly in the video signal line R1 corresponding to red where a change in luminance is easily recognized by humans, humans easily recognize degradation in the image quality of a display screen. In view of this, display devices in which the last video signal line to be driven in each group is not a video signal line corresponding to a specific color (here, blue) are outside the scope of the present invention.

Although, as an example of a display device that performs color display by video signal line time division drive, a liquid crystal display device that drives video signal lines in the order shown in FIG. 3 has been described so far, various display devices can be configured by the same method. First, the order of driving 12 video signal lines in each group may be arbitrary as long as the numbers of times the video signal lines are influenced by push-up are 2/0 or 0/2 and the last video signal line to be driven is a video signal line corresponding to blue.

In a display device of the present invention, the last video signal line to be driven in each group should be a video signal line corresponding to a specific color (e.g., blue) and it is preferred that the first video signal line to be driven in the group be a video signal line corresponding to the specific color, which is, however, not necessarily required. Also, instead of grouping the video signal lines every 12 video signal lines, the video signal lines may be grouped every s video signal lines (s is an integer greater than or equal to two).

Color display using a scheme other than an RGB scheme may be performed by providing pixel circuits corresponding to, for example, white, cyan, and/or magenta, in addition to pixel circuits corresponding to red, green, and blue. In this case, the last (or the first and last) video signal line (s) to be driven in each group should be a video signal line corresponding to a color where it is most difficult for humans to recognize a change in luminance among colors used for color display. Pixel circuits may be arranged in a stripe-like fashion or in a honeycomb fashion as long as each alignment of pixel circuits in the second direction corresponds to any one of colors used for color display. Also, display devices other than liquid crystal display devices can be configured by the same method.

As described above, according to a liquid crystal display device according to the present embodiment and various display devices according to variants thereof, when color display is performed by driving video signal lines in a time division manner, vertical streaks and degradation in image quality due to insufficient charge can be prevented.

### INDUSTRIAL APPLICABILITY

A display device of the present invention provides an effect of preventing vertical streaks and degradation in image quality due to insufficient charge and thus can be used for various display devices such as liquid crystal display devices.

1. A display device that performs color display by driving video signal lines in a time division manner, the display device comprising:
a plurality of pixel circuits arranged side by side in a first and a second direction, each alignment of pixel circuits in the second direction corresponding to any one of colors used for color display;
a plurality of scanning signal lines, each of which is connected in a shared manner to pixel circuits aligned in the first direction;
a plurality of video signal lines, each of which is connected in a shared manner to pixel circuits aligned in the second direction, the video signal lines being grouped every predetermined number of video signal lines according to order of arrangement;
a scanning signal line drive circuit for selecting the scanning signal lines;
a video signal line drive circuit for outputting to each group of the video signal lines voltages to be applied to video signal lines in the group, in a time division manner during a horizontal scanning period; and
a video signal line selection circuit for selecting one video signal line from each group and providing voltages outputted from the video signal line drive circuit, to the selected video signal lines, respectively, wherein
order of driving video signal lines in each group varies between an even frame and an odd frame, and for each line, in one of the frames, even-numbered video signal lines in the group are driven earlier than odd-numbered video signal lines and in other one of the frames, the odd-numbered video signal lines in the group are driven earlier than the even-numbered video signal lines and a last video signal line to be driven in the group is a video signal line corresponding to a specific color.

2. The display device according to claim 1, wherein in addition to the last video signal line to be driven in the group, a first video signal line to be driven in the group is a video signal line corresponding to the specific color.

3. The display device according to claim 1, wherein the order of driving video signal lines in the group is reversed between the even frame and the odd frame.

4. The display device according to claim 1, wherein the order of driving video signal lines in the group varies between even lines and odd lines.

5. The display device according to claim 4, wherein the order of driving video signal lines in the group is reversed between the even frame and the odd frame.

6. The display device according to claim 4, wherein a result of adding up a drive order number for the even lines in the even frame, a drive order number for the odd lines in the even frame, a drive order number for the even lines in the odd frame, and a drive order number for the odd lines in the odd frame is same for all video signal lines in the group.

7. The display device according to claim 4, wherein the last video signal line to be driven in the group varies between a case of the even lines in the even frame, a case of the odd lines in the even frame, a case of the even lines in the odd frame, and a case of the odd lines in the odd frame.

8. The display device according to claim 7, wherein in addition to the last video signal line to be driven in the group, a first video signal line to be driven in the group varies between the case of the even lines in the even frame, the case of the odd lines in the even frame, the case of the even lines in the odd frame, and the case of the odd lines in the odd frame.

9. The display device according to claim 1, wherein the specific color is a color where it is most difficult for humans to recognize a change in luminance among the colors used for color display.

10. The display device according to claim 9, wherein
as the pixel circuits, pixel circuits corresponding to red, green, and blue are provided, and
the specific color is blue.

11. The display device according to claim 1, wherein
as the pixel circuits, pixel circuits corresponding to red, green, and blue are provided,
the video signal lines are grouped every 12 video signal lines, each group including video signal lines R1 to R4 corresponding to red, video signal lines G1 to G4 corresponding to green, and video signal lines B1 to B4 corresponding to blue and the video signal lines being arranged in order of R1, G1, B1, R2, G2, B2, R3, G3, B3, R4, G4, and B4, and
12 video signal lines in each group are driven in order of B1, R1, G2, R3, B3, G4, G1, R2, B2, G3, R4, and B4 for even lines in the even frame and in order of B2, R2, G1, B4, R4, G3, G2, B1, R1, G4, R3, and B3 for odd lines in the even frame and in order reverse to that for the even frame, for the odd frame.

12. The display device according to claim 1, wherein the pixel circuits each includes a liquid crystal capacitance.

13. A driving method for a display device that includes a plurality of pixel circuits arranged side by side in a first and a second direction, each alignment of pixel circuits in the second direction corresponding to any one of colors used for color display; a plurality of scanning signal lines, each of which is connected in a shared manner to pixel circuits aligned in the first direction; and a plurality of video signal lines, each of which is connected in a shared manner to pixel circuits aligned in the second direction, the video signal lines being grouped every predetermined number of video signal lines according to order of arrangement, the driving method comprising the steps of:
selecting the scanning signal lines;
outputting to each group of the video signal lines voltages to be applied to video signal lines in the group, in a time division manner during a horizontal scanning period; and
selecting one video signal line from each group and providing voltages each outputted in a time division manner, to the selected video signal lines, respectively, wherein
order of driving video signal lines in each group varies between an even frame and an odd frame, and for each line, in one of the frames, even-numbered video signal lines in the group are driven earlier than odd-numbered video signal lines and in other one of the frames, the odd-numbered video signal lines in the group are driven earlier than the even-numbered video signal lines and a last video signal line to be driven in the group is a video signal line corresponding to a specific color.
